(19) United States
(12) Patent Application Publication
(10) Pub. No.: US 2006/0143092 A1
(43) Pub. Date: Jun. 29, 2006

(54) Modular sex toys and sales thereof

(76) Inventors: P. Sander Gardos, San Francisco, CA (US); Brett Nachman, San Francisco, CA (US)

Correspondence Address: PERKINS COIE LLP, P.O. BOX 2168, MENLO PARK, CA, 94026, US

(21) Appl. No.: 11/228,907

(22) Filed: Sep. 16, 2005

Related U.S. Application Data
(60) Provisional application No. 60/638,940, filed on Dec. 23, 2004.

(51) Int. Cl. G06Q 30/00

(52) U.S. Cl. 705/26

(57) ABSTRACT

A method and apparatus for selection of a modular sex toy are provided. In one embodiment, a method of providing a sex toy is provided. The method includes providing a plurality of modular component options to a user through a user interface. The method also includes receiving selection of a plurality of modular components from the options. The method further includes determining a set of potential assembled sex toys including modular components of the plurality of modular components. The method also includes presenting the set of potential assembled sex toys to the prospective customer. In other embodiments, an apparatus is provided with a base and modular attachments, including a motor and components coupling the motor to a main tool and any attachments. Such embodiments may also include a power supply. In further embodiments, a method of selecting a sex toy by selecting components or characteristics is provided. Embodiments of various methods may also involve logging into a system and having preferences stored therein. In additional embodiments, a method of selecting a sex toy by responding to questions is provided. In other embodiments, a facility where modular sex toys may be assembled is provided.

### CROSS-REFERENCE TO RELATED APPLICATION

This application claims priority to provisional application Ser. No. 60/638,940 which was filed on Dec. 23, 2004, and which is hereby incorporated herein by reference.

### BACKGROUND

Sex is both a taboo subject and a huge commercial market. A customer may wish to purchase a sex toy, but not begin to know how to describe what is desired. Having to talk to someone about the subject may be more than enough to stop a decision to purchase. For the merchants selling to such customers, this presents a serious obstacle to completion of sales.

With the advent of the Internet, many options for shopping become available which were otherwise foreclosed. Product research over the world wide web can be anonymous, informative, and relatively painless. Unfortunately, information on the Internet can be overwhelming, and may not be written or presented at an appropriate level of detail. Purchasers of a sex toy may not want to know the technical specifications of the motor in the toy, if one is included. Such purchasers may not want to think about the presence of a motor in the toy. Similarly, purchasers may not understand industry jargon, such as “bullets” for short stumpy vibrating devices for example. Moreover, purchasers of such a toy may have a vague idea of what is desired, but no specific understanding. Thus, it may be useful to provide an interface which allows for research into a product and selection of features without requiring too much detailed knowledge of the product.

Additionally, purchasers of sex toys may have specific preferences. Aside from not knowing how to express these preferences, such purchasers may want something slightly different from the various products found. Rather than requiring someone to search for the perfect sex toy, it may thus be useful to provide a sex toy that can be made perfect (near-perfect).

For other customers, talking to someone is not as much of an obstacle. Actually going to a store is an option, but discretion is still important. Moreover, customization of a product and specific desires for product features may mean that simply choosing a product out of a catalog or off the rack is too much of an effort. Some products may have so many different potential features, that looking through all potential products would be too time-consuming. Thus, it may be useful to provide various options for matching a customer with a product.

### SUMMARY

Systems, apparatuses and methods are described and illustrated. In addition to the aspects of the present invention described in this summary, further aspects of the invention will become apparent by reference to the drawings and by reading the detailed description that follows.

In one embodiment, an apparatus suitable for use in sexual situations is provided. The apparatus includes a control module having a motor therein and a modular interface. The apparatus also includes a main tool interchangeably coupled to the modular interface of the control module. The main tool is coupled to receive power and control signals from the control module. The apparatus also includes a housing interchangeably coupled to the main tool and surrounding exposed surfaces of the main tool. The apparatus further includes a power supply. Note that other names or descriptions may be applied to the same types of products. For example, such products may be called massagers, marital aids, adult toys, novelty products, vibrators, personal or intimate products, among other names.

In an alternate embodiment, an apparatus suitable for use in sexual situations is provided. The apparatus includes a base module having a modular interface. The apparatus also includes a main tool interchangeably coupled to the modular interface of the base module. The apparatus further includes a housing interchangeably coupled to the main tool and surrounding exposed surfaces of the main tool.

In another embodiment, a method of providing a sex toy is provided. The method includes interviewing a prospective customer about aspects of the sex toy. The method further includes matching customer preferences from the interview to features of modular components available for assembly into a sex toy to select a set of modular components. The method also includes determining a set of potential assembled sex toys including modular components of the set of modular components. Additionally, the method includes presenting the set of potential assembled sex toys to the prospective customer.

In yet another embodiment, an apparatus suitable for use in sexual situations is provided. The apparatus includes a control module having a motor therein and a modular interface. The apparatus also includes a main tool interchangeably coupled to the modular interface of the control module. The main tool is coupled to receive power and control signals from the control module. The apparatus further includes a first attachment. The first attachment is interchangeably coupled to the modular interface of the control module. The apparatus similarly includes a second attachment. The second attachment is also interchangeably coupled to the modular interface of the control module. The apparatus further includes a housing coupled to the main tool and surrounding exposed surfaces of the main tool. The apparatus also includes a power supply. The apparatus further includes a remote control, the remote control operatively coupled to the control module.

In still another embodiment, a method of providing a sex toy is provided. The method includes receiving a customer login request. The method also includes logging a prospective customer in. The method further includes retrieving a customer profile responsive to the customer login request for the prospective customer. The method also includes interviewing the prospective customer about aspects of the sex toy. The method further includes matching customer preferences from the interview to features of modular components available for assembly into a sex toy. This allows selection of a set of modular components. Also, the method includes determining a set of potential assembled sex toys including modular components of the set of modular components. Moreover, the method includes presenting the set of potential assembled sex toys to the prospective customer. Additionally, the method includes receiving a selection from the prospective customer of a toy of the set of potential assembled sex toys. Furthermore, the method includes processing an order for the selection. Also, the method includes delivering a product corresponding to the selection.

In yet another embodiment, an apparatus for facilitating selection of a sex toy is provided. The apparatus includes means for interviewing a prospective customer about aspects of the sex toy. The apparatus also includes means for matching customer preferences from the interviewing to features of modular components available for assembly into a sex toy. The apparatus further includes means for determining a set of potential assembled sex toys including modular components matched by the means for matching.

In another embodiment, an apparatus suitable for use in sexual situations and constructed based on user preferences is provided. The apparatus includes a control module having a motor therein and a modular interface. The control module is selected from a set of control modules having a common modular interface responsive to a user preference. The apparatus further includes a main tool interchangeably coupled to the modular interface of the control module. The main tool is coupled to receive power and control signals from the control module. The main tool is selected responsive to a user preference from a set of main tools each coupleable to the modular interface. The apparatus also includes a housing interchangeably coupled to the main tool and surrounding exposed surfaces of the main tool. The housing is selected responsive to a user preference from a set of housings each coupleable to the main tool. The apparatus further includes a power supply coupled to the control module. The power supply is selected responsive to a user preference from a set of power supplies coupleable to the control module.

In still another alternate embodiment, a system for sales of modular sex toys is provided. The system involves a location. The location houses an order reception unit to receive orders. The location also houses an on-demand assembly unit to assemble modular sex toys out of modular components responsive to customer requests as contained in orders. The orders are received from the order reception unit. The location also houses a modular component storage facility to hold modular components and to supply the modular components to the on-demand assembly unit. The location further houses a delivery unit to deliver modular sex toys from the on-demand assembly unit to customers responsive to orders from the order reception unit.

In yet another embodiment, a method of providing a sex toy is provided. The method includes providing a plurality of modular component options to a user through a user interface. The method also includes receiving selection of a plurality of modular components from the options. The method further includes determining a set of potential assembled sex toys including modular components of the plurality of modular components. The method also includes presenting the set of potential assembled sex toys to the prospective customer.

In another alternate embodiment, an apparatus suitable for use in sexual situations is provided. The apparatus includes a base module having a modular interface. The apparatus also includes a main tool interchangeably coupled to the modular interface of the base module. The apparatus further includes a housing interchangeably coupled to the main tool and surrounding exposed surfaces of the main tool.

### BRIEF DESCRIPTION OF THE DRAWINGS

Embodiments of the invention are illustrated in the figures. However, the embodiments and figures are illustrative rather than limiting, they provide examples of the invention.

FIG. 1A illustrates an embodiment of a modular sex toy or personal device.

FIG. 1B illustrates an embodiment of a remote control useful with a modular sex toy.

FIG. 1C illustrates a partial cut-away view of the modular sex toy of FIG. 1A.

FIG. 1D illustrates an exploded view of the modular sex toy of FIG. 1A.

FIG. 1E illustrates a cross-section of the exploded view of FIG. 1D.

FIG. 1F illustrates an exploded view of an alternate embodiment of a modular sex toy.

FIG. 2 illustrates an embodiment of a process of fulfilling an order for a sex toy.

FIG. 3 illustrates an alternate embodiment of a process of fulfilling an order for a sex toy.

FIG. 4 illustrates an embodiment of a process of interviewing a user about a sex toy.

FIG. 5 illustrates an alternate embodiment of a process of interviewing a user about a sex toy.

FIG. 6 illustrates a medium which may embody instructions useful for causing a processor to execute and thereby implement an embodiment.

FIG. 7 illustrates an embodiment of several computer systems that are coupled together through a network.

FIG. 8 illustrates one embodiment of a conventional computer system.

FIG. 9 illustrates an embodiment of a system useful in sales of modular sex toys.

FIG. 10 illustrates an embodiment of a process of a set of selections which results in a modular sex toy.

FIG. 11A illustrates an alternate embodiment of a modular sex toy.

FIG. 11B illustrates the modular sex toy of FIG. 11A with a housing included.

FIG. 12A illustrates an alternate embodiment of a housing.

FIG. 12B illustrates another alternate embodiment of a housing.

FIG. 12C illustrates yet another alternate embodiment of a housing.

FIG. 13A illustrates still another alternate embodiment of a housing.

FIG. 13B illustrates another alternate embodiment of a housing.

FIG. 13C illustrates an alternate embodiment of a housing.

### DETAILED DESCRIPTION

Systems, apparatuses and methods are described and illustrated. In addition to the aspects of the present invention described in this summary, further aspects of the invention will become apparent by reference to the drawings and by reading the detailed description that follows.

A method and apparatus for selection of a modular sex toy are provided. The invention, in some embodiments, may be expected to provide modular components which may be assembled into a sex toy or similar device based on required or desired features. The invention, in other embodiments, may be expected to provide a facility by which a user or customer may select a sex toy based on desired features or qualities of the product, potentially without requiring specific selection of each modular component. Thus, in some embodiments, a product may be selected as if it were made of modular components, but a non-modular product may be supplied. In particular, popular modules may be manufactured without using modular components, such as when a business judgment suggests that a custom design is more cost-effective and/or easier to handle.

In one embodiment, an apparatus suitable for use in sexual situations is provided. The apparatus includes a control module having a motor therein and a modular interface. The apparatus also includes a main tool interchangeably coupled to the modular interface of the control module. The main tool is coupled to receive power and control signals from the control module. The apparatus also includes a housing interchangeably coupled to the main tool and surrounding exposed surfaces of the main tool. The apparatus further includes a power supply. Note that other names or descriptions may be applied to the same types of products. For example, such products may be called massagers, marital aids, adult toys, novelty products, vibrators, personal or intimate products, among other names.

In an alternate embodiment, an apparatus suitable for use in sexual situations is provided. The apparatus includes a base module having a modular interface. The apparatus also includes a main tool interchangeably coupled to the modular interface of the base module. The apparatus further includes a housing interchangeably coupled to the main tool and surrounding exposed surfaces of the main tool.

In another embodiment, a method of providing a sex toy is provided. The method includes interviewing a prospective customer about aspects of the sex toy. The method further includes matching customer preferences from the interview to features of modular components available for assembly into a sex toy to select a set of modular components. The method also includes determining a set of potential assembled sex toys including modular components of the set of modular components. Additionally, the method includes presenting the set of potential assembled sex toys to the prospective customer.

In yet another embodiment, an apparatus suitable for use in sexual situations is provided. The apparatus includes a control module having a motor therein and a modular interface. The apparatus also includes a main tool interchangeably coupled to the modular interface of the control module. The main tool is coupled to receive power and control signals from the control module. The apparatus further includes a first attachment. The first attachment is interchangeably coupled to the modular interface of the control module. The apparatus similarly includes a second attachment. The second attachment is also interchangeably coupled to the modular interface of the control module. The apparatus further includes a housing coupled to the main tool and surrounding exposed surfaces of the main tool. The apparatus also includes a power supply. The apparatus further includes a remote control, the remote control operatively coupled to the control module.

In still another embodiment, a method of providing a sex toy is provided. The method includes receiving a customer login request. The method also includes logging a prospective customer in. The method further includes retrieving a customer profile responsive to the customer login request for the prospective customer. The method also includes interviewing the prospective customer about aspects of the sex toy. The method further includes matching customer preferences from the interview to features of modular components available for assembly into a sex toy. This allows selection of a set of modular components. Also, the method includes determining a set of potential assembled sex toys including modular components of the set of modular components. Moreover, the method includes presenting the set of potential assembled sex toys to the prospective customer. Additionally, the method includes receiving a selection from the prospective customer of a toy of the set of potential assembled sex toys. Furthermore, the method includes processing an order for the selection. Also, the method includes delivering a product corresponding to the selection.

In yet another embodiment, an apparatus for facilitating selection of a sex toy is provided. The apparatus includes means for interviewing a prospective customer about aspects of the sex toy. The apparatus also includes means for matching customer preferences from the interviewing to features of modular components available for assembly into a sex toy. The apparatus further includes means for determining a set of potential assembled sex toys including modular components matched by the means for matching.

In another embodiment, an apparatus suitable for use in sexual situations and constructed based on user preferences is provided. The apparatus includes a control module having a motor therein and a modular interface. The control module is selected from a set of control modules having a common modular interface responsive to a user preference. The apparatus further includes a main tool interchangeably coupled to the modular interface of the control module. The main tool is coupled to receive power and control signals from the control module. The main tool is selected responsive to a user preference from a set of main tools each coupleable to the modular interface. The apparatus also includes a housing interchangeably coupled to the main tool and surrounding exposed surfaces of the main tool. The housing is selected responsive to a user preference from a set of housings each coupleable to the main tool. The apparatus further includes a power supply coupled to the control module. The power supply is selected responsive to a user preference from a set of power supplies coupleable to the control module.

In still another alternate embodiment, a system for sales of modular sex toys is provided. The system involves a location. The location houses an order reception unit to receive orders. The location also houses an on-demand assembly unit to assemble modular sex toys out of modular components responsive to customer requests as contained in orders. The orders are received from the order reception unit. The location also houses a modular component storage facility to hold modular components and to supply the modular components to the on-demand assembly unit. The location further houses a delivery unit to deliver modular sex toys from the on-demand assembly unit to customers responsive to orders from the order reception unit.

In yet another embodiment, a method of providing a sex toy is provided. The method includes providing a plurality of modular component options to a user through a user interface. The method also includes receiving selection of a plurality of modular components from the options. The method further includes determining a set of potential assembled sex toys including modular components of the plurality of modular components. The method also includes presenting the set of potential assembled sex toys to the prospective customer.

In another alternate embodiment, an apparatus suitable for use in sexual situations is provided. The apparatus includes a base module having a modular interface. The apparatus also includes a main tool interchangeably coupled to the modular interface of the base module. The apparatus further includes a housing interchangeably coupled to the main tool and surrounding exposed surfaces of the main tool.

An object may be coupleable to another object when a well-defined option for coupling the two objects may be understood based on the objects themselves, such as through a common interface designed for such coupling, or through a well-known intermediary (intermediary object) designed for such coupling.

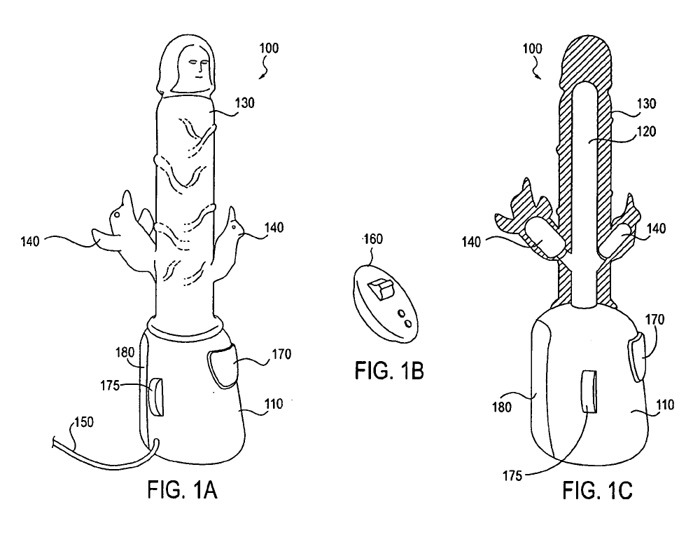

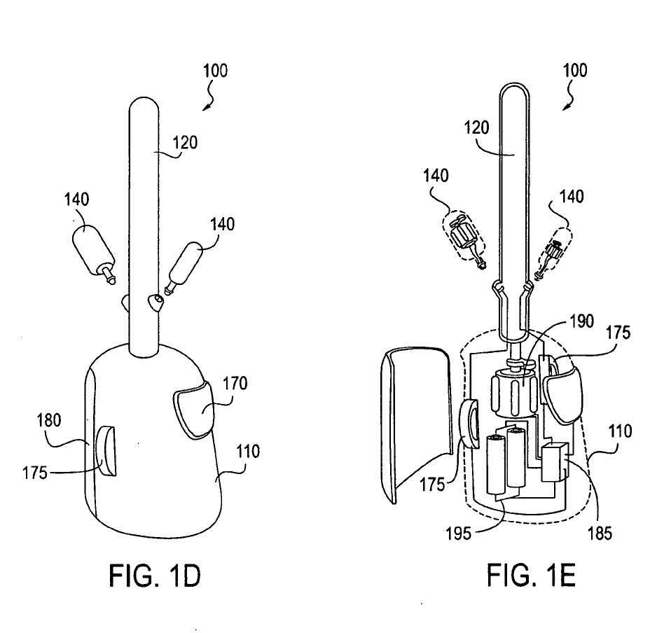

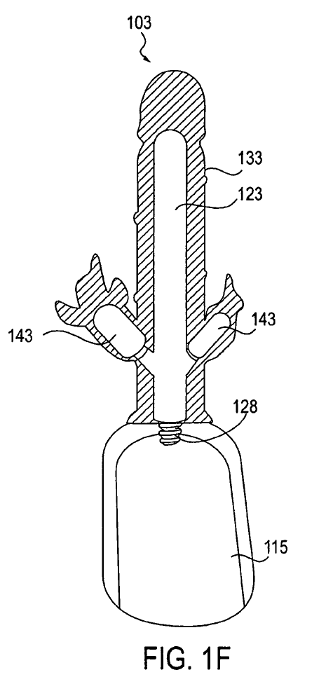

Various products may be used with various embodiments of the invention. FIG. 1A illustrates an embodiment of a modular sex toy. Unit 100 is representative of various structures which may be used, generally including a control base, main tool, housing, and power supply, and optionally including attachments and/or a remote control for example. Specifically, unit 100 includes control base 110 which includes user controls and any motorized components. Control base 110 also includes a modular interface allowing for coupling of other devices or components to the control base 110, whether to receive electric power, mechanical power, control signals, or structural stability for example. Control base 110 or control module 110 may have various features, including a simple on/off switch, speed settings, power settings, and a communications receiver for a remote control 160. An embodiment of remote control 160 is illustrated in FIG. 1B.

Main tool 120 is coupled to the interface of control base 110 and may be expected to at least receive power and any applicable control signals from control base 110. Main tool 120, for example, may be a plug or an elongated tool (as shown), or a bullet, for example. Bullets are known as small tools having a domed end away from the interface with the control module 110, but otherwise having a very short and stubby design. Moreover, main tool 120 may have various features, including vibrating, spinning, or swirling modes for example. Typically, main tool 120 would perform one of vibrating, spinning or swirling, but some embodiments may perform multiple modes. Additionally, main tool 120 may include beads of different or varying sizes. These are all aspects of a potential main tool 120 which may be chosen—prefabricated main tools 120 may be used interchangeably with the interface of control module 110, such that desired features or aspects of a main tool 120 are combined with a desired control base 110.

Also, main tool is typically covered or sheathed in a housing 130, which surrounds exposed surfaces of main tool 120. Housing 130 may be latex, plastic, elastomeric, or some other material. Moreover, housing 130 may have various textures, such as smooth surfaces, ridged surfaces, bumpy surfaces, or other surfaces. These are all aspects or features of a housing 130, which may be further mixed and matched with main tool 120 and control unit 110.

In some embodiments, an attachment 140 is added. In yet other embodiments, two attachments 140 (which may or may not be identical) are added. Attachment 140 is a second (or third) tool, typically with its own housing and its own coupling to the interface of control unit 110. In many embodiments, attachment 140 (or both attachments 140) are much smaller tools than the main tool 120. Moreover, in many embodiments, various attachments may be interchanged within the scope of the overall design. However, in some embodiments, control module 110 may not have an interface which allows for multiple attachments 140, or it may not have an interface which allows for any attachments 140.

In many embodiments, some form of controls will be present on the toy 100. As illustrated, switch 170 is provided as a main control, which may be a button-type on/off switch, or may have a more involved protocol, allowing for multiple presses of the button to change the function of the device. Also illustrated is an auxiliary control 175, which may be used to control one of the attachments 140, providing independent control. Alternatively, a surface feature such as a knob or bump may be provided in place of auxiliary control 175, to provide ease of handling (a place to grip). Also illustrated is door 180, which may be a panel providing access to the interior of toy 100.

Typically, some embodiments will be provided with a cord 150 or similar physical connection to a power source—the cord 150 acts as a power supply. Alternatively, an internal power source may be provided in control base 110 or as part of a modular component added to control base 110. Such an internal power source may be a battery (or set of batteries) or some similar object capable of storing electrical charge or other energy.

Further exploration of a specific embodiment may provide additional features which may be incorporated into various modular sex toys or similar devices. FIG. 1C illustrates a partial cut-away view of the modular sex toy of FIG. 1A. As can be seen, main tool 120 is covered by housing 130. Housing 130 also covers attachments 140. FIG. 1D illustrates an exploded view of the modular sex toy of FIG. 1A. As can be seen, attachments 140 engage with main tool 120 in this embodiment. Attachments 140 may also engage with base 110 in other embodiments.

FIG. 1E illustrates a cross-section of the exploded view of FIG. 1D. Each of attachments 140 include vibration components, along with a coupling for receiving either electrical or mechanical power. In this embodiment, a main moter 190 is positioned in the base 110, which powers main tool 120, providing mechanical power to main tool 120. Switches 175 are positioned to interrupt the flow of electricity to each of attachments 140 in this embodiment.

Motor 190 and switches 175 are coupled to a power supply or controller 185, which regulates flow of electricity within the toy 100, and also receives signals from switch (button) 170. Power supply 185 is coupled in turn to batteries 195, which provide the electrical power source for this toy 100. In other embodiments, an electrical cord may be used to plug into an electrical outlet for power supply purposes.

It is also instructive to note that modular devices need not be motorized. FIG. 1F illustrates an exploded view of an alternate embodiment of a modular sex toy. Device 103 is a product, such as a sex toy, made in a modular fashion.

Device 103 includes a base 115, which may be hollow or solid, and may come in various shapes. Attached thereto in a modular fashion is main tool 123. In particular, main tool 123 has a threaded end 128, which screws into a threaded receptacle of base 115. Attached to main tool 123 are attachments 143. Note that attachments 143 may be attached directly to base 115 in some embodiments. Additionally, tools without attachments may be provided, and tools with a receptacle for a single attachment may be used, too. Covering tool 123 and attachments 143 is housing 133, which may be similar or identical to housing 130 of FIG. 1A. Note that other names or descriptions may be applied to the same types of products. For example, such products may be called massagers, marital aids, adult toys, novelty products, vibrators, personal or intimate products, among other names.

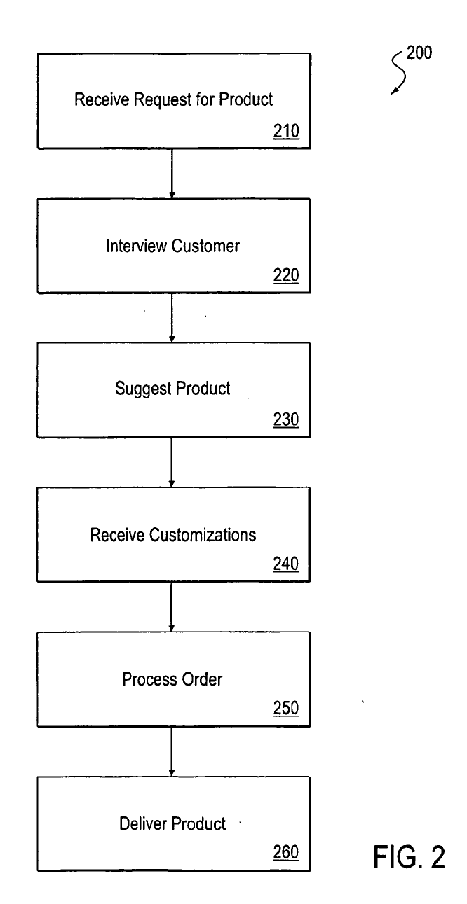

With the various modular parts of a sex toy available, it may be useful to provide a system or method for determining which parts to include in a custom product. FIG. 2 illustrates an embodiment of a process of fulfilling an order for a sex toy. Process 200 is an embodiment of a system or process for handling a request for a customizable sex toy without overwhelming a customer with options. The process includes a customer request, customer interview, suggestion of a product, further customization, processing a resulting order and delivering a product. This process (200) and other processes described and illustrated in this document may be implemented as a series of modules, such as process modules or physical modules for execution of parts of a process, and such modules may be reordered, rearranged, combined and subdivided.

Process 200 begins at module 210 with receipt of a request for a product from a potential customer. Such a request may simply be initiation of a process of selecting a product, such as by pressing a button on a user interface or asking for help from someone. In some embodiments, the product is some form of a sex toy. At module 220, the potential customer is interviewed, such as through a user interface. While customer interviews are discussed later in this document, it should be understood that a customer interview refers to a process or interface useful for receiving information from a customer, preferably without overwhelming the customer with either overly numerous choices or high levels of technical details. Thus, the interview may take on different forms in different contexts.

For example, a process may involve a customer interacting with a computer and selecting from menus of choices or answering questions in an interview. Alternatively, an interview may involve a customer answering questions over a phone connection with an automated (machine) or human process for receiving the answers. Moreover, an interview may include having a customer enter a storefront and communicate preferences with a store representative (e.g. employee). Likewise, an interview may involve filling out a questionnaire in a catalog or magazine to determine preferences, for example.

Having received further customer preference information at module 220, a product is suggested at module 230. The product suggested is based on the information received at module 220, thereby allowing for elimination of some potential modular components from a product, and allowing for selection of some remaining modular components for the suggested product based on likely alignment of customer preferences with modular component characteristics. A single product may be suggested, a predetermined number of products may be suggested, or a wide range of products may be suggested, depending on the expected preferences of the potential customer.

Evaluating information and suggesting a product may be done in a variety of ways based on interview techniques. For example, a computer-based implementation may compare responses to a set of statistical information about what customers prefer to arrive at suggestions. In a non-computer context answers to questions may lead to a process of following a decision tree of some form to find suggested products. Such a tree may be implemented for use by employees of a store, for example, or users of a catalog, for example.

After the product is suggested at module 230, further customizations may be received at module 240. For example, waterproofing may be available as an option, as may a remote control. Such options may be customized at module 240. Similarly, personalization may be available, such as engraving a name on the product for example.

Having allowed for further customization, at module 250 the resulting order is processed. This may involve sending a bill of materials and order to a manufacturing or assembly facility for example, along with shipping information. This may further involve receiving and processing payment for the product. Once the product is complete and paid for, it may be delivered to the customer at module 260. In some embodiments, delivery is implemented through known systems such as postal systems, and may be done on a discreet basis.

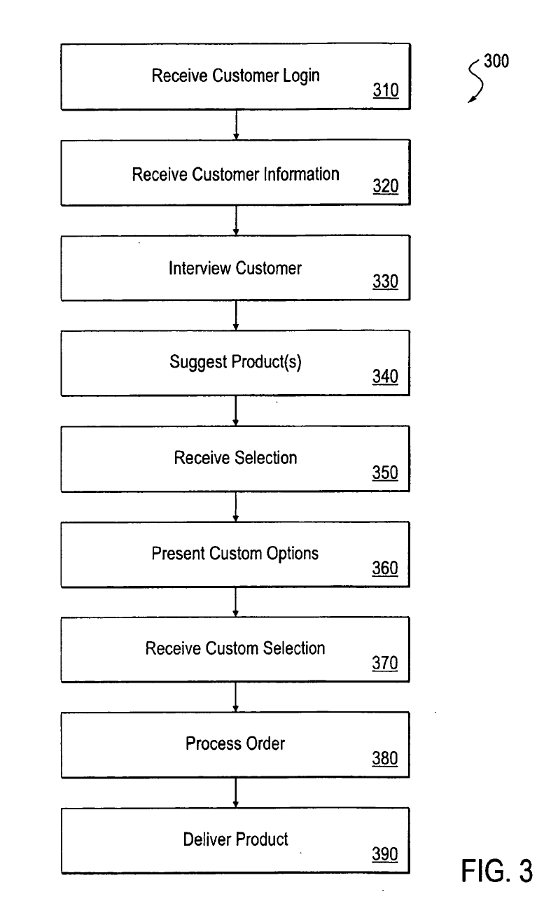

Alternative methods may also be employed to facilitate customer selection of a modular sex toy. FIG. 3 illustrates an alternate embodiment of a process of fulfilling an order for a sex toy. Process 300 includes a customer login, retrieving customer data, interviewing the customer, suggesting a product based on the interview, receiving a selection, presenting custom options, receiving custom selections, processing the order and delivering the product. Such a process (and other processes described in this document) may be reordered to execute in parallel or in series for example, or otherwise rearranged.

Process 300 begins at module 310 with receipt of a customer login request. The customer is logged in to the system. Additionally, specific customer data from prior transactions or visits is retrieved at module 320, such as through retrieval/lookup of a customer profile. Specific customer information may include information as simple as shipping details and methods of payment, and may also include prior purchase information, demographic information, preferences, and other customer-specific information. Note that logging in and retrieving a profile may be optional, or need not even be implemented in some embodiments or variations.

At module 330, the potential customer is interviewed, such as through a user interface. Customer interviews are discussed elsewhere in this document. Such an interview may involve questioning the customer about various different preferences related to available products. Whether the questions are directly related to product features, or indirectly related and likely to suggest product features, the results are recorded as data which may be factored into an analysis of which products to suggest.

Having received customer preference information at module 330, further analysis is done and a product is suggested at module 340. The product suggested is based on the information received at module 330, and on any available information in a customer profile retrieved at module 320.

The analysis for module 340 may be performed in a variety of ways. For example, an interview may produce a set of answers to questions. Those answers may be matched against features of modular components. For example, an answer that someone wanted a gentle product may match well with low-power products and less well with high-power products. Similarly, an answer that someone dislikes latex may match well with elastomeric material and (presumably) not match with latex. In general, such forms of evaluation are known and implementable. The analysis may also include information from a customer profile, such as information about products the customer owns or has purchased, for example. Thus, duplication of previously purchased products may be avoided (or suggested if the match is very close).

Once the analysis is complete with regard to various modular components, the combinations of those modular components may be determined, potentially with additional weighting of results for combinations of closely matched modular components. A single product (a collection of modular components) may be suggested, a predetermined number of products may be suggested, or a wide range of products may be suggested, depending on the expected abilities or interests of the potential customer.

After the product is suggested at module 340, a product selection is received at module 350. Further customizations may be presented at module 360. Customizations such as waterproofing, remote controls, or personalization may be offered, for example. Moreover, customizations to make the product suitable as a gift may be provided. Choices for such customizations may be made (received) at module 370.

The resulting order is processed at module 380. This may involve sending a bill of materials and order to a manufacturing or assembly facility for example, along with shipping information. Additionally, this may involve creation of custom instructions for the product, potentially taking into account customizations of module 370, such as names engraved for example. This may further involve receiving and processing payment for the product. Once the product is complete and paid for, it may be delivered to the customer at module 390. In some embodiments, delivery is implemented through known systems such as postal systems, and may be done on a discreet basis.

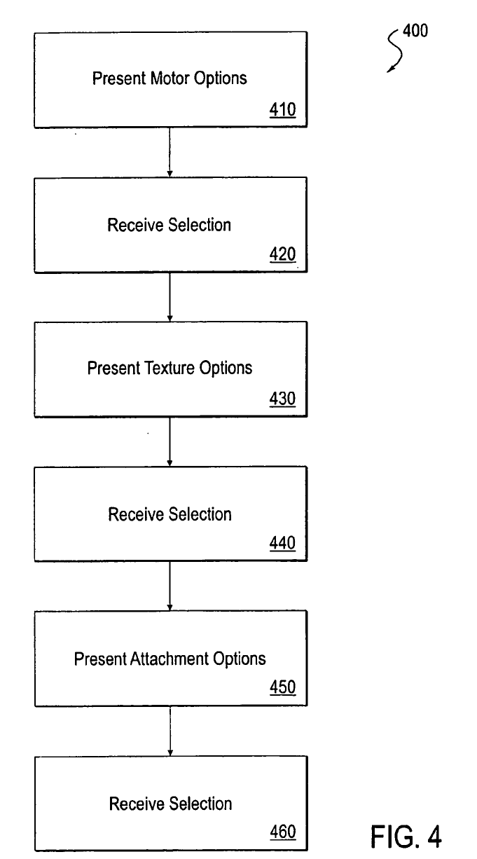

Various methods for interviewing a customer may be employed. Preferably, the interview process (or questionnaire) will allow for collection of useful information while avoiding needless technical details and overwhelming numbers of choices. FIG. 4 illustrates an embodiment of a process of interviewing a user about a sex toy. Process 400 includes presenting options related to motors, texture, and attachments, and receiving selections or preferences from the user. Obviously, additional data may be collected (options presented and selections received), such as types of tools for example.

Process 400 begins at module 410, with presentation of motor options. Options may be various features of motors such as power, number of speeds or adjustability, and other similar features. At module 420, customer preferences for a motor are received. This may involve a choice of various options, such as selecting a radio button from a group of buttons on a user interface, or a selection from a drop-down menu for example.

At module 430, texture options are presented. Texture may be as simple as smooth, bumpy, ridged, rough, or other textures for example. At module 440, a selection of texture is received. Again, this selection may be made through various user interface features.

At module 450, attachment options are presented. Attachment options may include no attachment, one attachment, or multiple attachments. Moreover, attachment options may include various types of tools. At module 460, the customer's preference for attachments is received.

At the conclusion of the interview process, data may be packaged for use by other parts of an application or other programs, for example. Moreover, data may be included in a customer profile. Additionally, the interview process may include collection of other data, such as data related to other product features for example.

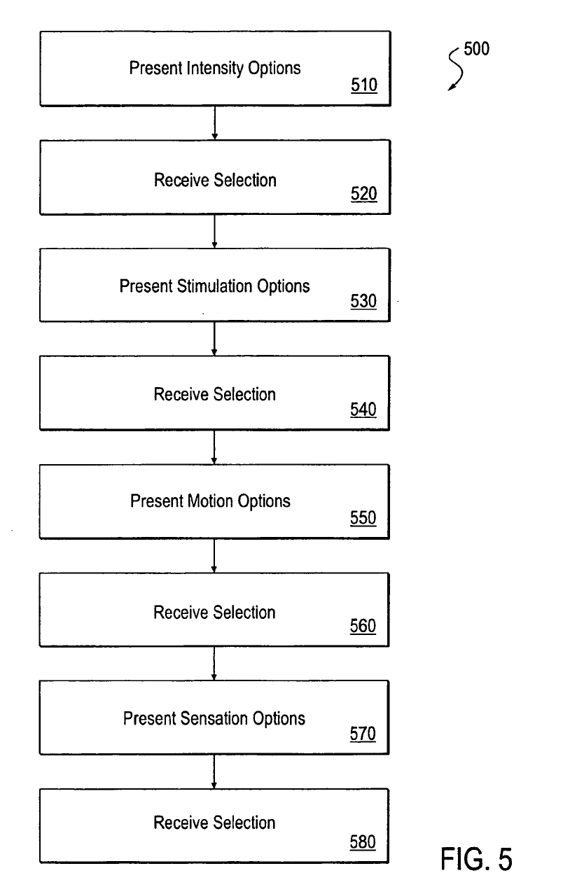

The interview process of FIG. 4 presents one embodiment of an interview, but other embodiments may also be available. FIG. 5 illustrates an alternate embodiment of a process of interviewing a user about a sex toy. Process 500 includes presenting options related to intensity, stimulation, motion, and sensation, and receiving selections from those options. Other embodiments may capture data on similar subjects, or on related but different subjects.

At module 510, intensity options are presented. These options may be presented in a variety of ways. For example, intensity may be described as high, medium, or low. Alternatively, intensity may be described as overwhelming, strong, middling, or weak for example. At module 520, a selection of one of the intensity options is received.

At module 530, stimulation options are presented. Stimulation may also be described in a variety of ways. For example, stimulation may be described as singular, dual or multiple. Alternatively, stimulation may be described as clitoral, vaginal, oral or anal for example. At module 540, a selection of one of the stimulation options is received.

At module 550, motion options are presented. As may be expected, motion may be described in a variety of ways. For example, motion may be described as vibrating, spinning, swirling, pulsating, or thrusting. A selection of one (or more) motion options is received at module 560.

At module 570, sensation options are presented. Sensation options may also be described in various ways. For example, sensation may be described as smooth, uneven, rough, or undulating. At module 580, a selection of a sensation option is received from the customer.

The data thus received may be packaged for use with other program components or applications, for example. Moreover, the data may lead to follow-up questions within the interview (not shown). Additionally, the data may be correlated with information from the customer profile to determine trends related to customer characteristics (such as location, age, etc.)

While interviews have generally been discussed, some users may prefer overwhelming data or large numbers of choices. This may be true because the customer wants to know all choices, or is familiar with various different modular components, or because the customer has a perverse desire to choose from all options. Alternatively, this may be true because the customer is in charge of ordering modular sex toys for a store, for example, and thus does not need or want the interview process to interfere with an attempt to get exactly what is desired. In such instances, an alternative user interface may be used, such as one which involves presentation of all or most alternatives for a particular component and selection of one or more such alternatives. This may be done as a series of selections for each component, or may be done as a selection of (for example) one component of each group on a single user interface display (e.g. screen) presenting all such options, for example.

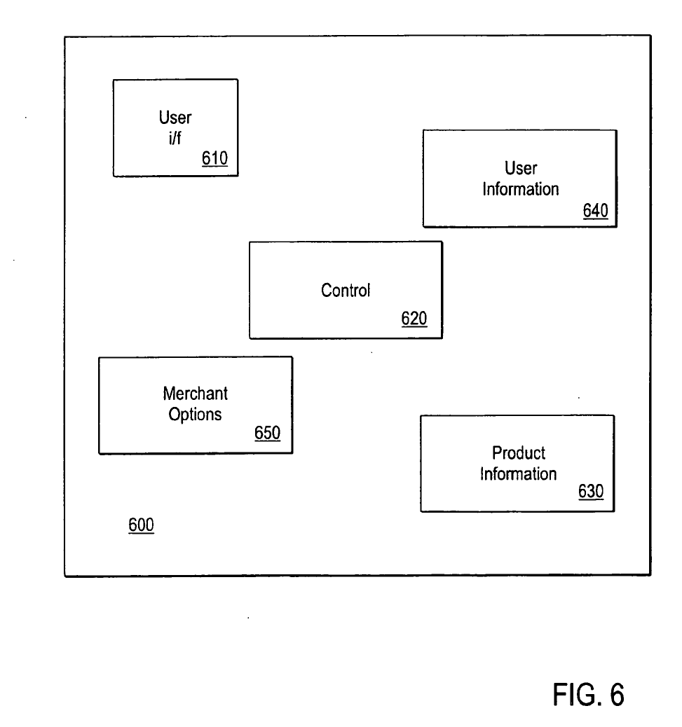

Implementation of the methods described may be accomplished as part of a program embodied in a machine-readable medium. FIG. 6 illustrates a medium which may embody instructions useful for causing a processor to execute and thereby implement an embodiment. Medium 600 includes a user interface module, a control module, a product information module, a user information module and a merchant options module. Each of these modules may be implemented in a variety of ways, and functionality of the various modules may be shifted from one module to another depending on implementation-specific details.

Medium 600 embodies user interface 610 for use by customers in selecting a sex toy. Note that user interface 610 may be simply the specific parts or customizations of an available user interface as are needed for the application of medium 600. Control module 620 controls user interface 610, determining which aspects of the interface should be displayed for example. Control module 620 also determines when to retrieve information through product information module 630, user information module 640 and merchant options module 650.

Product information module 630 may be an interface to a database or data structure containing information about the various modular components available to make up a sex toy. Alternatively, product information module 630 may contain the information about the various modular components. Thus, product information module may, in various embodiments, be expected to supply identifying information for modular components, and to supply information about features of the components, including predetermined measures of how well the components match features which may be selected in an interview process.

User information module 640 may similarly be an interface to external data, or a database. User information module 640 may, in various embodiments, provide personal information about a customer, such as name, address, payment method, etc. Additionally, user information module 640 may provide transaction history, preferences, and personal characteristics for example.

Control module 620 may be expected to analyze data received from user interface 610 in conjunction with data received from product information module 630 and/or user information module 640. Control module 620 may also be expected to direct execution of the other modules (610, 630, 640, and 650). Control module 620 may interact with merchant options module 650 to implement merchant (seller-specific or distributor-specific) policies for example. Thus, merchant options module 650 may provide information on which products are in great supply or are back-ordered for example. Merchant options module 650 may also be used to handle regulatory compliance, such as by eliminating options which would violate local laws based on a location from a customer profile.

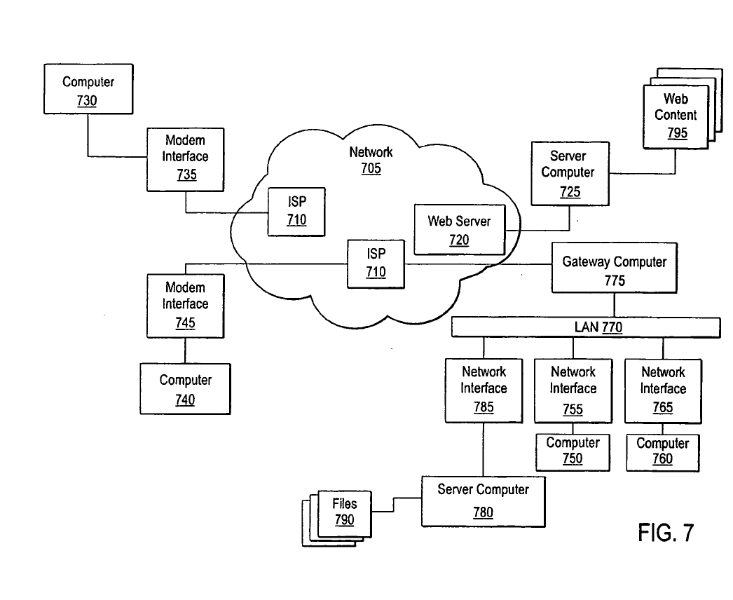

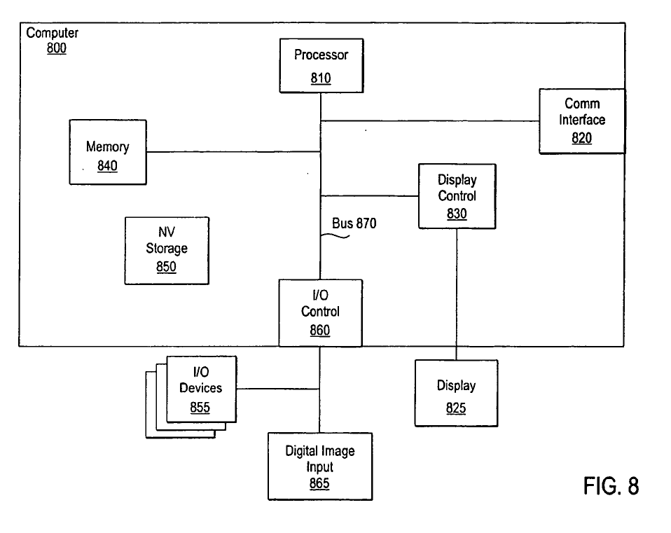

The following description of FIGS. 7-8 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the Internet. The term “Internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the world wide web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a web tv system, or other such computer system.

Similarly, the ISP 715 provides Internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 8 shows one example of a conventional computer system that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

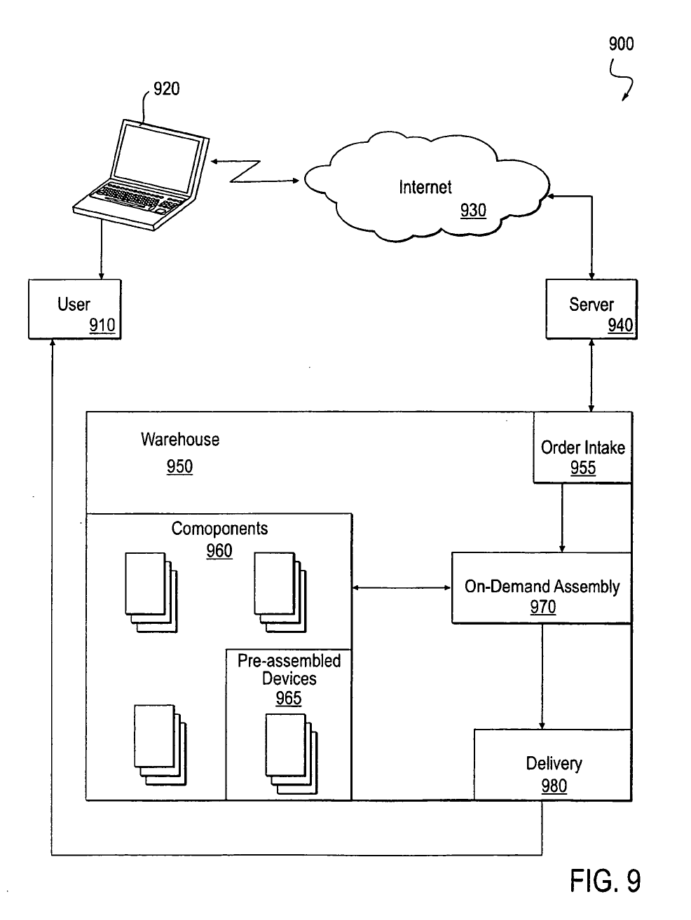

Various overall systems may be used to accomplish sales of modular sex toys, including various components discussed above. FIG. 9 illustrates an embodiment of a system useful in sales of modular sex toys. System 900 may be implemented in a variety of ways, to allow a user to order a modular sex toy or to allow a store-owner to replenish (order) an inventory of modular sex toys. System 900 allows a user to operate a terminal, to place an order over the Internet to a server. System 900 further allows a warehouse to accept the order from the server, assemble the ordered device on-demand (responsive to the order) and deliver the device to the user.

User 910 operates a terminal or computer 920 (a machine). Computer 920 is coupled to the Internet 930 or a similar network allowing for data transmission over a distance. Also coupled to the Internet 930 is a server 940 which is used by a warehouse (or factory) 950. Thus, user 910 may order a modular sex toy at computer 920, have that order transmitted to server 940 via Internet 930, and have the warehouse 950 receive that order. User 910 may order the modular sex toy in question through use of the various methods described above, or through a similar method or embodiment.

Warehouse 950 is illustrated schematically—many details are not illustrated in order to avoid obscuring pertinent details. Order intake 955 may represent an interface to server 940, such as a printer or terminal for example. On-demand assembly 970 may be an assembly line, an automated assembly device, even a set of workers trained to assemble modular sex toys.

Components 960 are used in assembly of the modular sex toys—the components 960 are the modular components used which make up the modular sex toys and may be assembled in a variety of combinations as a result of the modular nature of these components. Components 960 may also include pre-assembled devices, either partially assembled or completely assembled in nature. Such pre-assembled devices may be made when demands are slack, and may be made based on projections of which devices are likely to be requested (e.g. which devices have proven popular).

Thus, on-demand assembly may make devices when no order has been placed, using components 960, and then store the pre-assembled devices 965 as inventory with components 960. Whether a device is pre-assembled or assembled responsive to a demand, it may then be sent to user 910 through delivery 980, which may be as simple as a shipping or shipping and receiving operation. Not illustrated is a component inventory management system, which may be used to forecast demand for modular components and to manage supplies of such components 960, for example.

Terminal 920 is discussed in terms of a computer or machine. Where this device is located may have varying effects, too. For example, terminal 920 may be a computer in a customer's home. However, terminal 920 may also be a kiosk in a store, allowing a user to submit an order from the store and then have the item either shipped to the store or shipped home, for example. Moreover, terminal 920 may be a computer used by a store manager or similar person. In such an instance, the store manager may order modular sex toys in quantities expected to sell for inventory purposes, and thus may undergo a different interview process, for example. Alternatively, the store manager may order modular sex toys based on customer requests, for example. Similarly, the store manager may place orders based on models previously ordered, based on sales or popularity for example.

Note that another embodiment of the warehouse 950 may be an in-store embodiment. In such an instance, the Internet and server connections may not be necessary. Rather, order intake 955 may involve a sales person in the store, or a kiosk. On-demand assembly 970 may likewise occur on the premises. Moreover, pre-assembled devices 965 may be modular, or some popular models may not even be modular—they may be custom designs. On-demand assembly 970 may take from pre-assembled devices 965 and components 960 as necessary. Delivery 980 may then occur in the store, completing the purchase process.

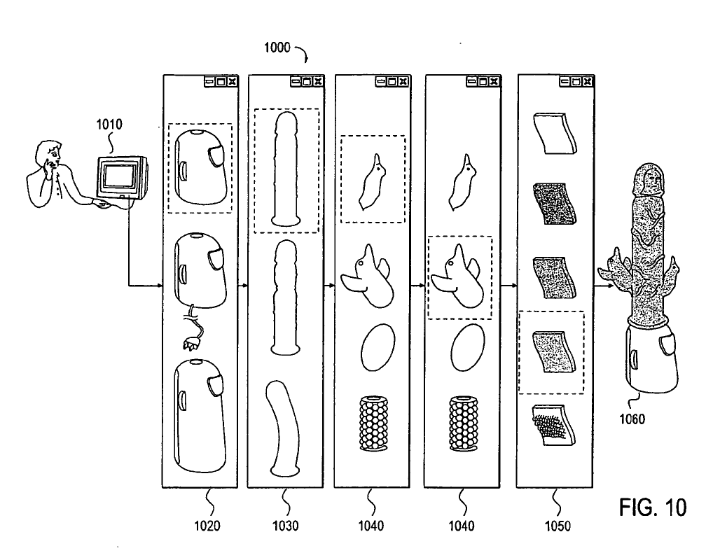

One embodiment of a process of ordering a modular sex toy may be illustrative in understanding how various processes may be implemented. FIG. 10 illustrates an embodiment of a process of a set of selections which results in a modular sex toy. Process 1000 is illustrated with a user at a terminal 1010 making a set of choices, resulting in an assembled modular sex toy 1060. Panel 1020 presents a variety of base models which may be selected, and a selection of a base model without a cord is illustrated.

Similarly, panel 1030 presents a variety of housings or sheathings which may be selected, and a selection is shown. Note that panel 1030 may alternatively present a variety of tools which may be selected—though the representation is based on a tool with a housing on it. Likewise, in presenting a choice of housings, a choice of tools may be implied, such that a curved housing would imply a choice of a curved tool, for example.

Panels 1040 provide a set of options for accessories. As illustrated, multiple accessories may be selected. In this particular embodiment, two different animal-shaped accessories are chosen to plug into the main tool of a modular sex toy. However, other accessories may be for use with the main tool, such as the beads shown. Also, choice of accessories may be accomplished in other ways, such as through selection of multiple options on a single panel 1040, or cycling through the panel 1040 several times until all accessory locations are filled or a request to not add further accessories is received.

The process also includes a selection from a set of options for texture or material of the housing at panel 1050. With all of these selections made, a modular sex toy 1060 may be displayed for the user, and an order for the chosen configuration may be placed. This may then result in assembly or retrieval (from inventory) of the modular sex toy 1060 and shipment to the user.

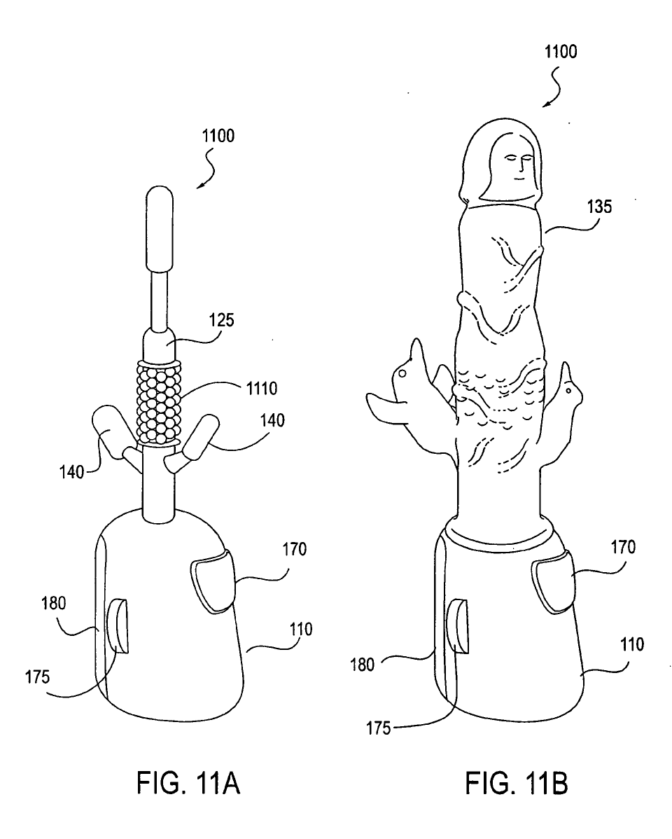

Alternate embodiments of modular sex toys may be desired. FIG. 11A illustrates an alternate embodiment of a modular sex toy. Most of toy 1100 is similar to toy 100 of FIGS. 1A-1E, and thus many components are shared. However, toy 1100 includes a different main tool 125, rather than tool 130 of toy 100. This tool 125 may be both longer and have a place for mounting bead attachment 1110, for example.

Bead attachment 1110 is a component with beads or ball bearings mounted therein to provide a changing texture during use of the tool. FIG. 11B illustrates the modular sex toy of FIG. 11A with a housing included. With housing 135 covering main tool 125 and bead component 1110, the appearance to toy 1100 is similar to toy 100. However, the effect of bead component 1110 is to provide a different texture in a portion of housing 135, and to have that texture change over time during operation of the toy 1100. This is believed to provide a more pleasurable experience for the user in some circumstances.

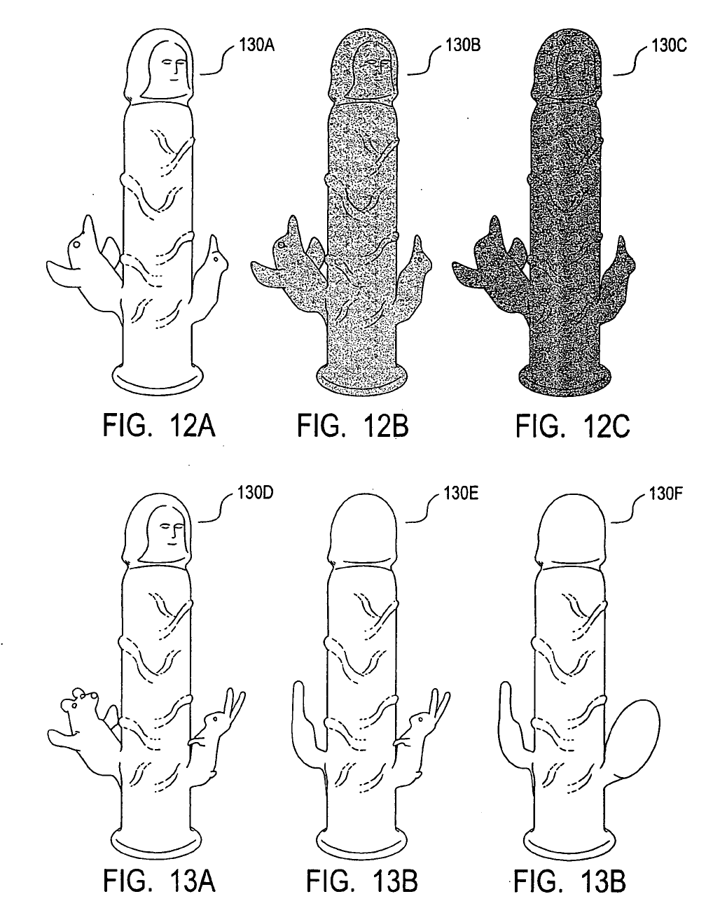

Variations of toy components may occur under different circumstances. One such variation is in housings. FIG. 12A illustrates an alternate embodiment of a housing. FIG. 12B illustrates another alternate embodiment of a housing. FIG. 12C illustrates yet another alternate embodiment of a housing. Housing 130A is shown in a light color. Housing 130B is shown in a slightly darker color (represented by shading) than housing 130A. Housing 130C is shown in a much darker color (again represented by shading) than housing 130B. Thus, color of housings may be varied. Also, material of the housing may be varied, to provide different textures and properties. More or less expensive materials may be used, from various types of plastics and similar materials to metals and alloys such as chrome or stainless steel for example.

Different shapes may also be used. FIG. 13A illustrates still another alternate embodiment of a housing. FIG. 13B illustrates another alternate embodiment of a housing. FIG. 13C illustrates an alternate embodiment of a housing. Housing 130D provides a housing with two different animal shapes for underlying attachments. Housing 130E replaces one animal attachment with a more abstract shape. Housing 130F replaces the other animal attachment with an egg or bullet shape. Other shapes may be used for the attachments. Similarly, different shapes may be used at the end of housings, and different textures may be used on the surface of housings, providing smoother or rougher surfaces, for example.

From the foregoing, it will be appreciated that specific embodiments of the invention have been described herein for purposes of illustration, but that various modifications may be made. For example, the disclosed methods and apparatuses have been described primarily in terms of interviews involving a series of queries and selections, while other interview formats (such as a binary decision format for example) may be used in the same manner. In some instances, reference has been made to characteristics likely to be present in various or some embodiments, but these characteristics are also not necessarily limiting on the spirit and scope of the invention. In the illustrations and description, structures have been provided which may be formed or assembled in other ways.

In particular, the separate modules of the various block diagrams represent functional modules of methods or apparatuses and are not necessarily indicative of physical or logical separations or of an order of operation inherent in the spirit and scope of the present invention. Similarly, methods have been illustrated and described as linear processes, but such methods may have operations reordered or implemented in parallel.

We claim:

1. A method of providing a sex toy, comprising:
interviewing a prospective customer about aspects of the sex toy;
matching customer preferences from the interviewing to features of modular components available for assembly into a sex toy to select a set of modular components;
determining a set of potential assembled sex toys including modular components of the set of modular components; and
presenting the set of potential assembled sex toys to the prospective customer.

2. The method of claim 1, wherein:
interviewing includes an online interaction of a user interface and the prospective customer.

3. The method of claim 1, wherein:
interviewing includes an in-person interaction of the prospective customer with an in-store set of options.

4. The method of claim 1, wherein:
interviewing includes an interaction of the prospective customer with a set of options in a catalog.

5. The method of claim 1, further comprising:
receiving a selection from the prospective customer of a toy of the set of potential assembled sex toys.

6. The method of claim 1, further comprising:
processing an order for the selection.

7. The method of claim 6, further comprising:
delivering a product corresponding to the selection.

8. The method of claim 1, wherein:
presenting the set of assembled sex toys includes presenting three selected assembled sex toys.

9. The method of claim 1, wherein:
interviewing includes asking the prospective customer about desired features in a sex toy.

10. The method of claim 1, wherein:
interviewing includes asking the prospective customer about expected uses of a sex toy.

11. The method of claim 1, wherein:
interviewing includes asking the prospective customer about expected results of use of a sex toy.

12. The method of claim 1, further comprising:
receiving a selection from the prospective customer of a toy of the set of potential assembled sex toys;
processing an order for the selection; and
delivering a product corresponding to the selection.

13. The method of claim 12, further comprising:
receiving a customer login request;
logging the prospective customer in; and
retrieving a customer profile responsive to the customer login request for the prospective customer.

14. The method of claim 1, wherein the method is performed by a processor, responsive to execution by the processor of a set of instructions, the instructions embodied in a machine-readable medium.

15. An apparatus for facilitating selection of a sex toy, comprising:
means for interviewing a prospective customer about aspects of the sex toy;
means for matching customer preferences from the interviewing to features of modular components available for assembly into a sex toy; and
means for determining a set of potential assembled sex toys including modular components matched by the means for matching.

16. The apparatus of claim 15, further comprising:
means for presenting the set of potential assembled sex toys to the prospective customer.

17. The apparatus of claim 16, further comprising:
means for presenting the set of potential assembled sex toys to the prospective customer.

18. A method of providing a sex toy, comprising:
providing a plurality of modular component options to a user through a user interface;
receiving selection of a plurality of modular components from the options;
determining a set of potential assembled sex toys including modular components of the plurality of modular components; and
presenting the set of potential assembled sex toys to the prospective customer.

19. The method of claim 18, wherein:
the set of potential assembled sex toys includes only a single potential assembled sex toy including all modular components of the plurality of modular components.

20. The method of claim 18, wherein:
the plurality of modular components are grouped into like components as perceived by a user of the user interface.

21. The method of claim 20, wherein:
the user interface restricts a user to choosing no more than one modular component from a group.

22. The method of claim 20, wherein:
the user interface allows a user to choose multiple modular components from a group.

23. The method of claim 22, wherein:
the set of potential assembled sex toys includes a plurality of potential assembled sex toys each including some but not all modular components of the plurality of modular components.

24. A system for sales of modular sex toys, comprising:
a location housing:
an order reception unit to receive orders;
an on-demand assembly unit to assemble modular sex toys out of modular components responsive to customer requests as contained in orders, the orders received from the order reception unit;
a modular component storage facility to hold modular components and to supply the modular components to the on-demand assembly unit; and
a delivery unit to deliver modular sex toys from the on-demand assembly unit to customers responsive to orders from the order reception unit.

25. The system of claim 24, wherein:
the order reception unit is coupled to the Internet.

26. The system of claim 25, wherein:
the order reception unit is coupled through a server to the Internet.

27. The system of claim 25, wherein:
the order reception unit receives orders from individuals ordering from home.

28. The system of claim 25, wherein:
the order reception unit receives orders from individuals ordering at a kiosk in a store.

29. The system of claim 25, wherein:
the order reception unit receives orders from individuals ordering on behalf of a store.

30. The system of claim 24, wherein:
the modular component storage facility further holds modular sex toys assembled from modular components.

31. The system of claim 25, wherein:
the order reception unit receives orders from individuals ordering at a storefront coupled to the order reception unit.
